(19) United States
(12) Patent Application Publication
(10) Pub. No.: US 2010/0225565 A1
(43) Pub. Date: Sep. 9, 2010

(54) MIPI ANALOG SWITCH FOR EFFICIENT SELECTION OF MULTIPLE DISPLAYS

(76) Inventors: Oscar W. Freitas, Cape Elizabeth, ME (US); James B. Boomer, Monument, CO (US)

Correspondence Address: CESARI AND MCKENNA, LLP, 88 BLACK FALCON AVENUE, BOSTON, MA, 02210, US

(21) Appl. No.: 12/399,359

(22) Filed: Mar. 6, 2009

(51) Int. Cl. G09G 5/00

(52) U.S. Cl. 345/2.1

(57) ABSTRACT

An MIPI controller using undefined or unknown MIPI LP codes to select among several destinations is disclosed. The codes may be intercepted and decoded to select among analog switches that, in one illustrative embodiment, connects the MIPI clock and data signals to a first or a second or to both displays of a mobile phone. In other applications additional destinations may also be selected.

### BACKGROUND OF THE INVENTION

1. Field of the Invention

The present invention relates to sharing data among two or more destinations, and more particularly to efficiently switching among the destinations using an MIPI (Mobile Industry Processor Interface).

2. Background Information

Mobile phones are constrained in how many signals can be sent in the flip, clam shell and slide phones. MIPI interfaces have minimized the signal lines by serializing the data to the two displays commonly found in such phones. An MIPI interface typically has a single clock, CLK, and most commonly two parallel data “lanes,” D1 and D2 although the minimum is just one data lane. These three signals are carried by differential pairs of wires. Since the MIPI is a point-to-point interface a separate GPIO (general purpose I/O) signal is employed with an analog switch to select between the two displays.

Herein “coupled,” and “connected’ are used interchangeably and may include other relatively passive components that do not substantially alter the functions being described.

FIG. 1 illustrates an MIPI interface 2 communicating with two displays 4 and 6 of a dual display mobile phone. The MIPI interface 2 is shown within an application processor 8, but it may be shown as a stand alone controller. The input of an analog switch 10 connects the MIPI lines to one or the other of displays 4 and 6 depending on the state of the analog switch 10. An additional GPIO 14 signal, SEL 16, selects one of the displays.

Some issues with the prior art include the use of an additional IO interface that must be separately addressed, and the single SEL line provides only two states, each of which selects one display 4 or 6.

The MIPI specification is known to those skilled in the art. That specification is briefly described below to provide an environment framework for the present invention. More detailed information can be obtained by referring to the specification itself. An MIPI interface has a high speed (HS) operation where D1 and D2 data lanes operate differentially to indicate a 1 or a 0. An MIPI interface also has a Low Power (LP) operation, where each of the two wires, referenced as Dp and Dn, of a data lane are driven independently. So in LP operation there are four possible states of the Dp and Dn wires: 11, 10, 01, and 00. Note in this notation value of each Dp and Dn pair occur at the same time In HS operation if both the Dp and Dn wires of a data lane are driven high, for a minimum required time, that lane enter a STOP or CONTROL state.

When in the CONTROL state the sequence of data on the Dp, Dn wires may define a request to enter an ESCAPE mode, that sequence is LP-11, LP-10, LP-00, LP-01, LP-00. The sequence may be written as LP-11>10>00>01>00. Once in the ESCAPE mode, an eight bit command may be sent via “Spaced-One-Hot” coding. This coding means that sending a logic 1, termed Mark-1 or a logic 0, termed a Mark-0, is interleaved with a Space state (a zero), where each of the Mark's and Space consists of two parts. That is a Mark-1 is defined as a LP-10 (Dp=1, Dn=0), and a Mark-0 is a LP-01 and a Space is a LP-00. For example, sending a “one” via a LP MIPI interface in the ESCAPE mode would be the following sequence: LP-10>00; and sending a “zero” sequence would be LP-01>00.

### SUMMARY OF THE INVENTION

The present invention addresses some of the issues of the prior art by interfacing two or more displays without an external GPIO or other such interface. The present invention recognizes that “undefined” and “unknown” commands exist in the MIPI specification, where subsequent data may be used to control the selection in this case among two or more displays.

The present invention provides at least two advantages over prior art systems. First, the MIPI may address more than one display without using a GPIO, and second, data may be sent to all or a group of displays simultaneously.

It will be appreciated by those skilled in the art that although the following Detailed Description will proceed with reference being made to illustrative embodiments, the drawings, and methods of use, the present invention is not intended to be limited to these embodiments and methods of use. Rather, the present invention is of broad scope and is intended to be defined as only set forth in the accompanying claims.

### BRIEF DESCRIPTION OF THE DRAWINGS

The invention description below refers to the accompanying drawings, of which:

FIG. 1 is a block diagram schematic of a prior art MIPI system;

FIG. 2 is a block diagram illustrating the present invention;

FIG. 3 is a schematic/block diagram representing the analog switch of FIG. 2;

FIG. 4 is a representative flow chart of an MIPI interface;

FIG. 5 is a table of data bit meanings; and;

FIG. 6 is schematic/block diagram of a controller of an analog switch, and

FIG. 7 is a timing diagram of entering the ESCAPE mode and a command.

### DETAILED DESCRIPTION OF AN ILLUSTRATIVE EMBODIMENT

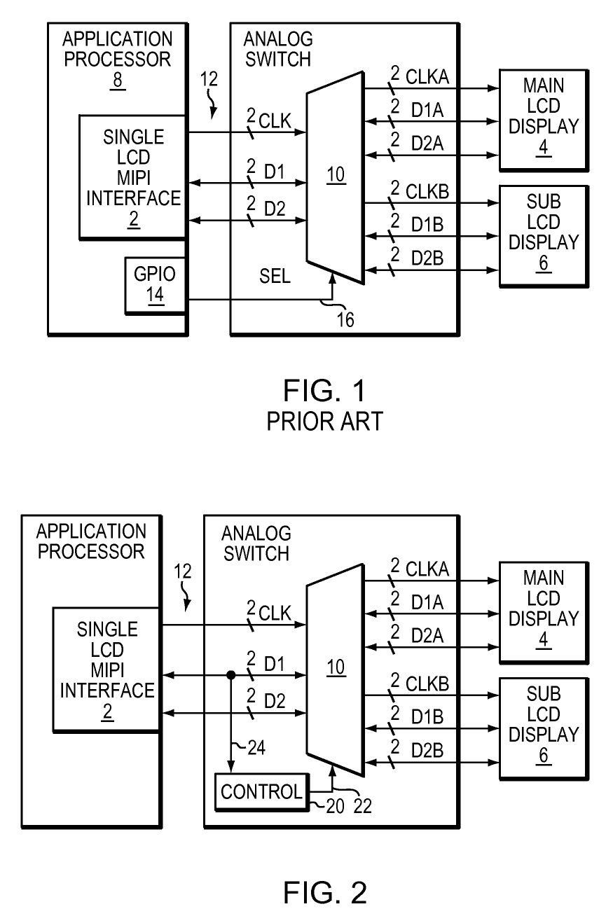

FIG. 2 is similar to FIG. 1 except that there is no GPIO SEL signal, and a Control block 20 is added. The input to the Control 20 is the MIPI data signal D1 (Dp, Dn) and output 22 controls the switches in the Analog Switch 10.

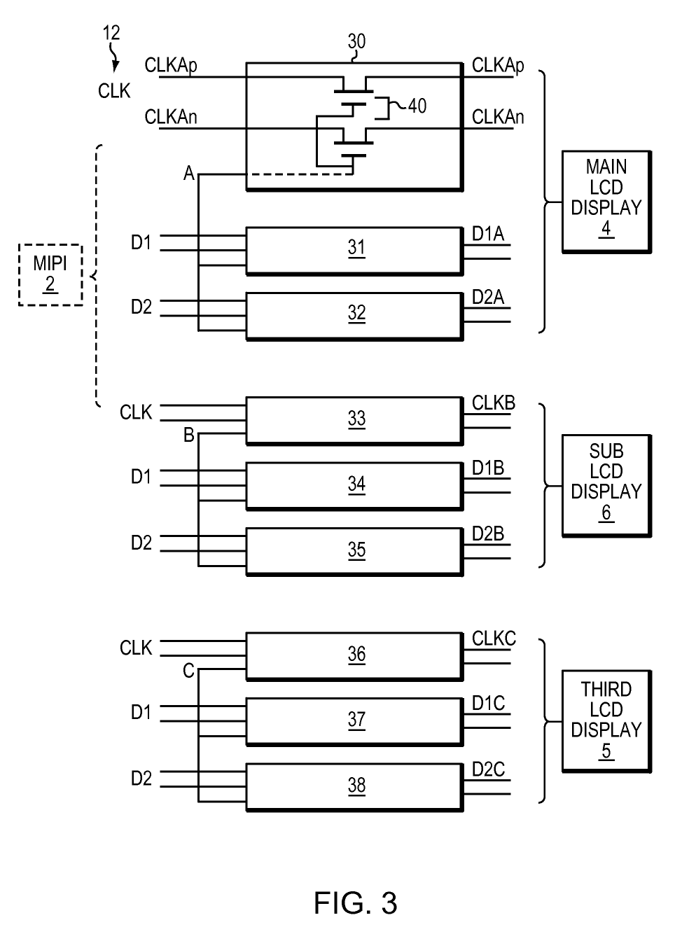

FIG. 3 represents the signals 12 from the single MIPI interface 2 that are input to the analog switches 30-38, arranged in three groups. Each of the switches 30-38 have a pair of MOSFETs 40 as shown in the representative block 30. Other circuits and component (not shown) known to those skilled in the art will be included in each of the blocks 30-38. When A is true, the MOSFETs 40 in blocks 30-32 will pass the CLK and D1 and D2 signals to the Main LCD Display 4, when B is true to the Sub LCD Display 6, and when C is true to the third LCD Display 5.

In some applications, the control signals, A, B, and C are not exclusive of each other and all or two of the three may be true at the same time. This would send the same data to all or two of the three displays at the same time.

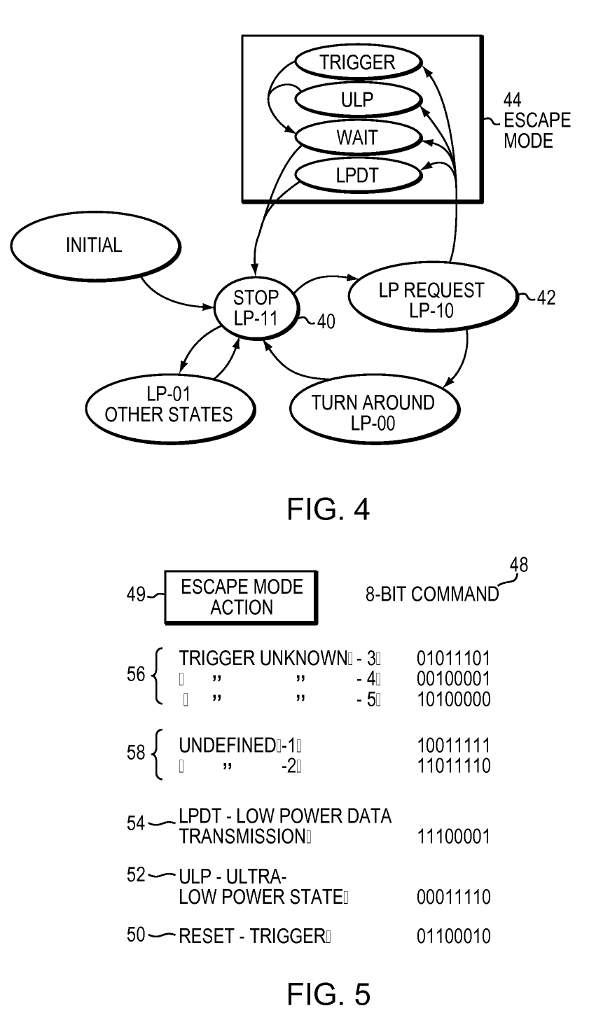

FIG. 4 represents part of an MIPI flow chart. Here, when the MIPI interface commands a STOP 40, both Dp and Dn are set true, LP-1, and if the LP-11 is followed by an LP-10, 42, the system is in a LP REQUEST mode, from which the MIPI interface may request entrance into the ESCAPE mode 44. In this embodiment there are four modes in the Escape Mode 44. One is the LPDT (Low Power Data Transmission) mode that may be followed immediately by data bytes, the others are the ULP (Ultra Low Power) mode; the WAIT mode; and the TRIGGER mode.

As mentioned above, to enter the ESCAPE mode 44, the sequence is LP-11>10>00>01>00 (Spaced-One-Hot code).

When in the ESCAPE mode, FIG. 5 illustrates the 8-bit commands 48 that may be sent on the Dp and Dn lines of the D1 data lane to select one action from the listed ESCAPE MODE ACTION 49. With reference to the above discussion, the eight bit commands are sent via 16 (two Dp, Dn states for each of the eight bits) states defined for the Spaced-One-Hot technique mentioned above. The RESET TRIGGER 50, the ULP 52, and the LPDT 54 are action commands. But the three TRIGGER UNKNOWN 56 and the two UNDEFINED 58 may be decoded to create the three signals A, B and C of FIG. 3. Moreover, one of the five undefined and unknown commands may activate A, B and C simultaneously. The codes for these five ESCAPE MODE ACTIONS 56 and 58 may be used singly and in combination to select analog switch connections.

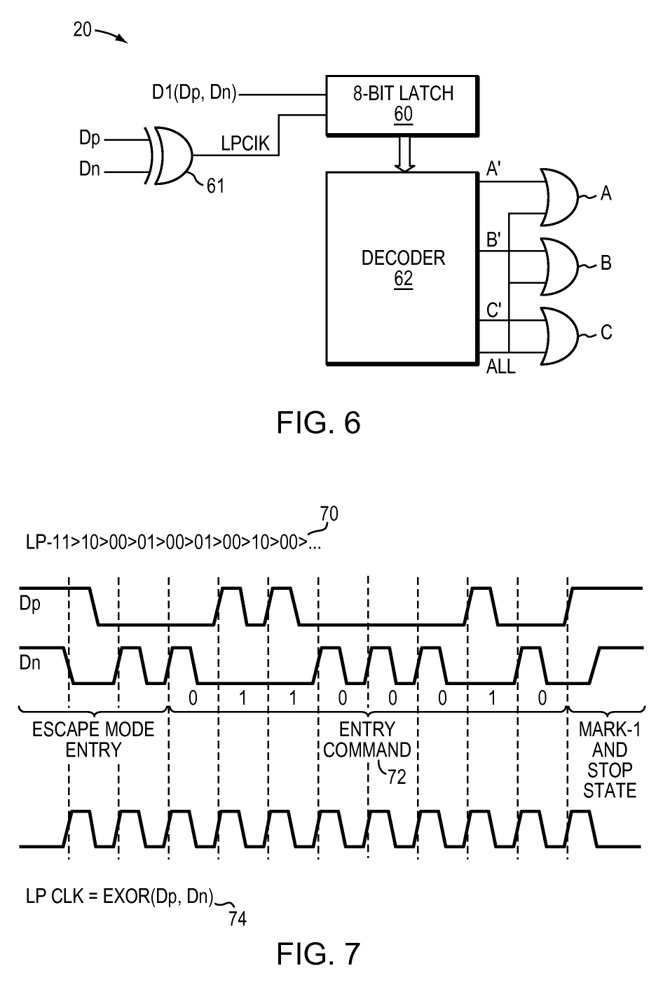

FIG. 6 illustrates activity within the controller 20 of FIG. 2. After the ESCAPE MODE 44 is entered, the succeeding Dp, Dn bits of D1 are latched 60 and decoded 62 to produce the A′, B′, C′ and ALL signals. The OR gates 64 provide the A, B, C, and ALL to activate the analog switch groups 30-38 singly or in parallel in this example. An exclusive or (EXOR) 61 of Dp and Dn will produce the LP CLK shown in FIG. 7, that loads the Dp and Dn signals into the latch 60.

FIG. 7 illustrates timing signals used for decoding the Dp and Dn signals from the D1 data lane when entering into the ESCAPE MODE and selecting an action. Here the action will be shown as the Reset Trigger Action 50 of FIG. 5. The LP sequence 70 is the sequence of the two lines, Dp and Dn, and note that there is a SPACE 00 between each data bit being sent, as discussed above. The Entry Command 72 for the RESET TRIGGER mode 50, that is the eight bit sequence data: 0, 1, 1, 0, 0, 0, 1, 0 (again sent as 16, Dp, Dn, states with Spaces-00 between each bit). As illustrated a clock signal that loads the sixteen bits may be generated by an exclusive OR 74 (the gate 61 of FIG. 6).

It should be understood that above-described embodiments are being presented herein as examples and that many variations and alternatives thereof are possible. Accordingly, the present invention should be viewed broadly as being defined only as set forth in the hereinafter appended claims.

What is claimed is:

1. Apparatus comprising:
an MIPI interface having a clock lane and at least one data lane, the at least one data lane defining first and second data signals;
at least one destinations;
an analog switch: having states that couple the MIPI interface to the at least one destination;
a controller having an input connected to the first data signal,
wherein the controller detects from the first data signal that the MIPI has entered into an escape mode;
a latch decoder that receives, when in the escape mode, bits from the first data signal; and
a decoder that decodes the bits to select the state of the analog switch.

2. The apparatus of claim 1 wherein the at least one destination defines three destinations, wherein the decoder decodes bits that select one of the three destinations.

3. The apparatus of claim 1 wherein the analog switch defines another state that couples simultaneously the MIPI interface to groups of two or more up to all the destinations, wherein the decoder decodes bits that select two or more or all the destinations.

4. The apparatus of claim 1 wherein the at least one data lane includes two, three or more data lanes.

5. The controller of claim 1 wherein the at least one destination includes more than three destinations.

6. A method for directing an MIPI interface to at least one destination, the method comprising the steps of:
on a data lane defining first and second data signals, driving both data signals with a data sequence such that the MIPI interface enters a STOP state; then a low power request state, followed by bits defining a command,
decoding the command;
outputting a signal from the decoded command, that connects the MIPI interface to the at least one destination.

7. The method of claim 6 wherein the command selects one of three destinations.

8. The method of claim 6 wherein the command selects groups of two or more or all the destinations.
